(19) United States
(12) Patent Application Publication
(10) Pub. No.: US 2011/0136363 A1
(43) Pub. Date: Jun. 9, 2011

(54) CONNECTOR DEVICE FOR CONNECTING A COLD CATHODE OF A NEON OR FLUORESCENT-TUBE LAMP TO A SUPPLY CABLE

(75) Inventor: Hassane Yaali, Rivoli (Torino) (IT)

(73) Assignee: Tyco Electronics AMP Italia S.R.L., Collegno(Torino) (IT)

(21) Appl. No.: 13/057,726

(22) PCT Filed: May 19, 2009
(86) PCT No.: PCT/IB2009/052074

§ 371 Date: Feb. 4, 2011

(30) Foreign Application Priority Data
Aug. 7, 2008 (IT) TO2008A000626

(51) Int. Cl. H01R 33/02

(52) U.S. Cl. 439/232; 439/226

(57) ABSTRACT

The present application relates to a connector device for connecting a cold cathode of a neon or fluorescent tube lamp to a supply cable comprises a first body in form of a tubular housing, inside which a metal sheet is provided having elastically deflectable teeth for engaging one end of the fluorescent tube. A second body of the connector device is associated to one end of the supply cable. The first and second bodies are respectively provided with first and second coupling elements in form of two concentric cylindrical rings made of an electrically conductive material, which engage one inside the other in the coupled condition of the first and second bodies. In this engagement condition, the two concentric rings lock therebetween bent terminal portions of a first wire connected to the electrode of the fluorescent tube and a second wire forming part of the supply cable.

### FIELD OF THE INVENTION

The present invention relates to a connector device for connecting a cold cathode of a neon or fluorescent-tube lamp to a supply cable.

Even though the invention is in general applicable to any type of fluorescent-tube lamp, a preferred application is constituted by the fluorescent tubes used for making light signs, for example on the walls of buildings, as illustrated purely by way of example in FIG. 1, where a building 1 is decorated with one or more light signs 2, as well as in FIG. 2, which illustrates a view at an enlarged scale of the sign 2. FIG. 3 illustrates a detail of FIG. 2, at a further enlarged scale, and shows one end of the fluorescent tube 3 defined by a glass body that is closed at said end by means of fusion welding. The device according to the invention, designated as a whole by the reference number 4 in FIG. 3, is designed to connect an electrode provided at the end of the fluorescent tube 3 with a supply cable 5, which is connected via a transformer (not illustrated) to the electric power-supply network.

### BACKGROUND OF THE INVENTION

The problem that the present invention seeks to solve is that of providing a connector device that will guarantee the possibility of making a rapid connection of the supply cable 5 to the fluorescent tube and will moreover guarantee a stability of positioning of the device itself on the end of the fluorescent tube.

A connector device according to the preamble of claim 1 is known from FR-A-2159567.

The object of the present invention is also to provide a connector device of the type referred to above that will have a relatively simple structure and will be economically advantageous to produce.

### SUMMARY OF THE INVENTION

With a view to achieving the above purposes, the subject of the present invention is a connector device for connecting an electrode of a fluorescent-tube lamp to a supply cable, said device being characterized in that it comprises:
a first body made of electrically insulating material, provided with means for its assembly on one end of the fluorescent tube;
a second body made of electrically insulating material, provided for being associated to one end of the supply cable; and
a first coupling element and a second coupling element carried, respectively, by the aforesaid first body and by the aforesaid second body and constituted by electrically conductive materials;
said first body and said second body being coupleable together in a condition in which said first and second coupling elements are in mutual engagement with interposition between them both of a first electrical conductor connected to the electrode of the fluorescent tube and of a second electrical conductor forming part of said supply cable;

in such a way that in the aforesaid condition of engagement the electrode of the fluorescent tube is connected electrically to said supply cable via said first electrical conductor, said first and second coupling element, and said second electrical conductor,

characterized in that said first and second coupling elements are constituted by two concentric cylindrical rings, substantially coaxial with the fluorescent tube.

In one embodiment, the two concentric cylindrical rings are designed to fit into one another with interposition both of a bent terminal part of said first electrical conductor and of a bent terminal part of said second electrical conductor.

In another embodiment, the second wire forming part of the supply cable has a bent terminal portion which is interposed between the rings when these are mutually engaged one within the other, so that these rings become locked with each other by friction, whereas the first wire connected to the electrode of the fluorescent tube is engaged within a clamp defined by projections formed in one-piece with the ring defining the first coupling element.

In addition, in both embodiments the aforesaid first body made of electrically insulating material is in the form of a substantially tubular casing provided inside with a diaphragm-like lamina having a peripheral portion rigidly connected to said casing and a plurality of elastically deformable internal teeth, which are designed to engage on the end of the fluorescent tube and to withhold the body of said casing on said tube.

Thanks to the aforesaid characteristics, the device according to the invention is able to remain stably in position on the end (FIG. 3) of the fluorescent tube 3, through the engagement of the elastically deformable teeth of the aforesaid metal lamina on the body of the fluorescent tube. At the same time, the connection between the electrode of the fluorescent tube and the supply cable can be obtained very rapidly by pre-arranging the two aforesaid cylindrical rings on the aforesaid first body and on the aforesaid second body and then mounting said rings one inside the other. Uncoupling can be obtained equally rapidly by exerting a force sufficient for extracting the inner ring from the outer ring so as to release the conductors.

### BRIEF DESCRIPTION OF THE DRAWINGS

Further characteristics and advantages of the invention will emerge from the ensuing description with reference to the annexed drawings, which are provided purely by way of non-limiting example and in which:

FIG. 1, already described above, is a perspective view of a building having a light sign provided by means of a fluorescent tube of the type for which the present invention is intended;

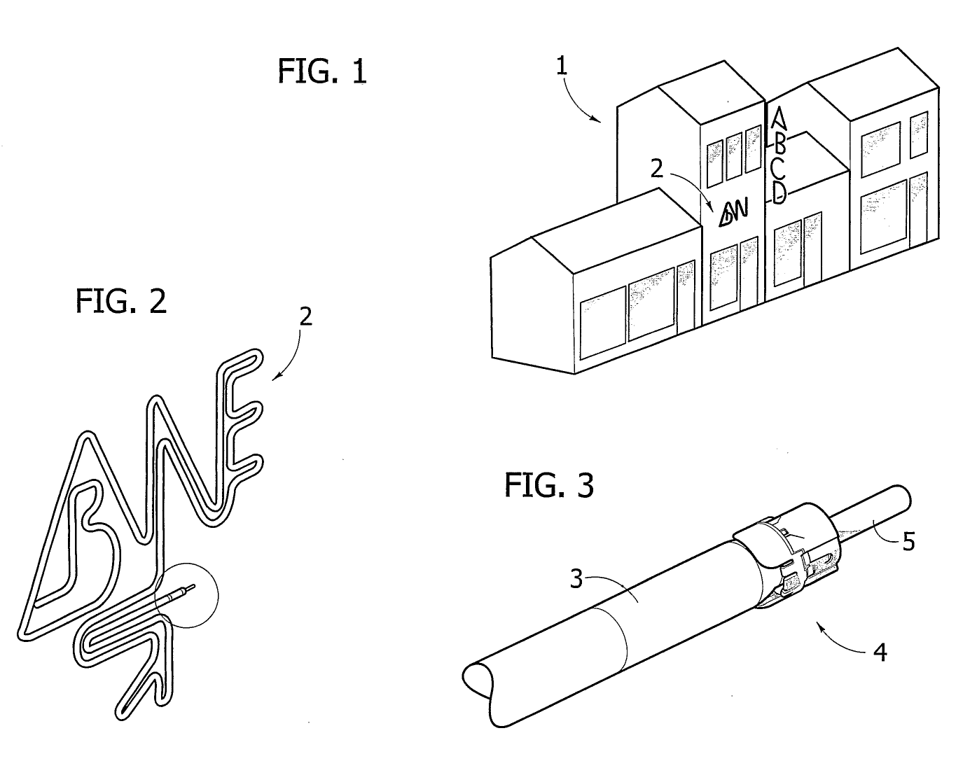

FIG. 2, already described above, is a perspective view at an enlarged scale of a detail of FIG. 1;

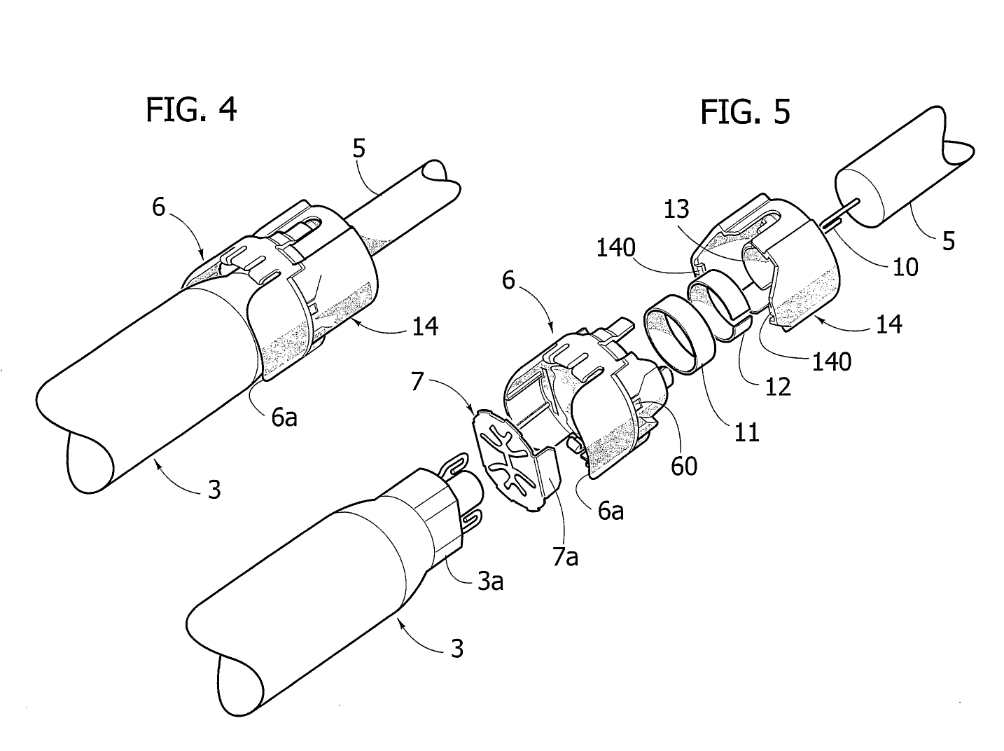

FIG. 3, already described above, is a perspective view at a further enlarged scale of a detail of FIG. 2;

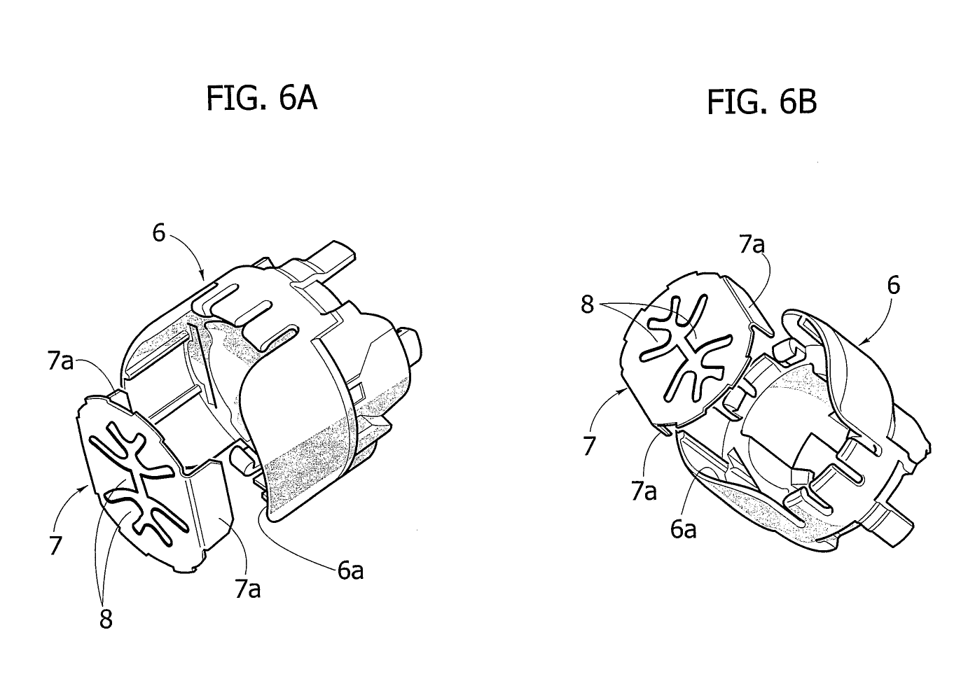

FIG. 4 is a perspective view of the detail of FIG. 3, at a slightly enlarged scale, which shows the connector device according to a first embodiment of the invention in the coupled condition;

FIG. 5 is an exploded perspective view of the device of FIG. 4;

FIGS. 6A, 6B, 7, 8A, 8B, 9, 10A, 10B, 11A, 11B illustrate successive steps of assembly of the connector device of FIG. 4;

FIG. 12 is a schematic cross-sectional view of the connector device of FIG. 4 in the mounted condition,

FIG. 13 is a perspective view of a second embodiment of the invention, in the coupled condition,

FIG. 14 is an exploded perspective view of the connector device of FIG. 13,

FIG. 15 is a view in cross-section and at an enlarged scale of a detail of FIG. 13,

FIG. 16 is an exploded perspective view at a further enlarged scale of some of the parts shown in FIG. 15,

FIG. 16 is a partially broken perspective view of the first body of the connector device of FIG. 13,

FIG. 18 is a perspective view of the second body with its associated parts, and

FIG. 19 is a further perspective view of the first body of FIG. 17.

### DETAILED DESCRIPTION OF THE INVENTION

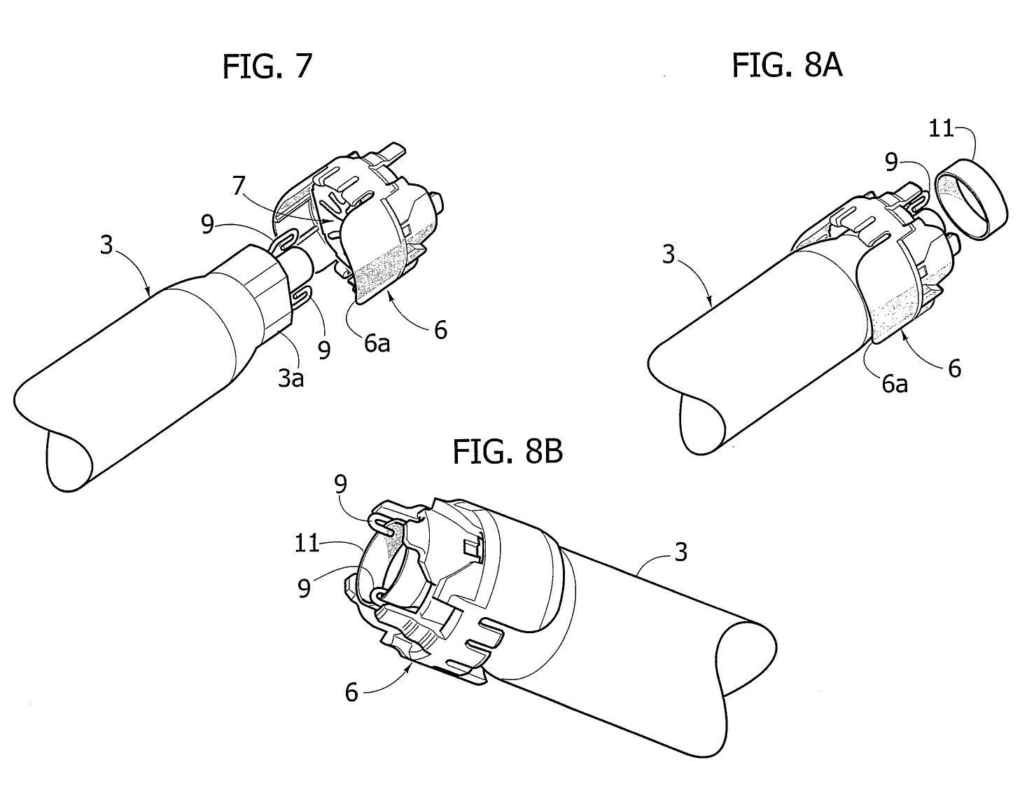

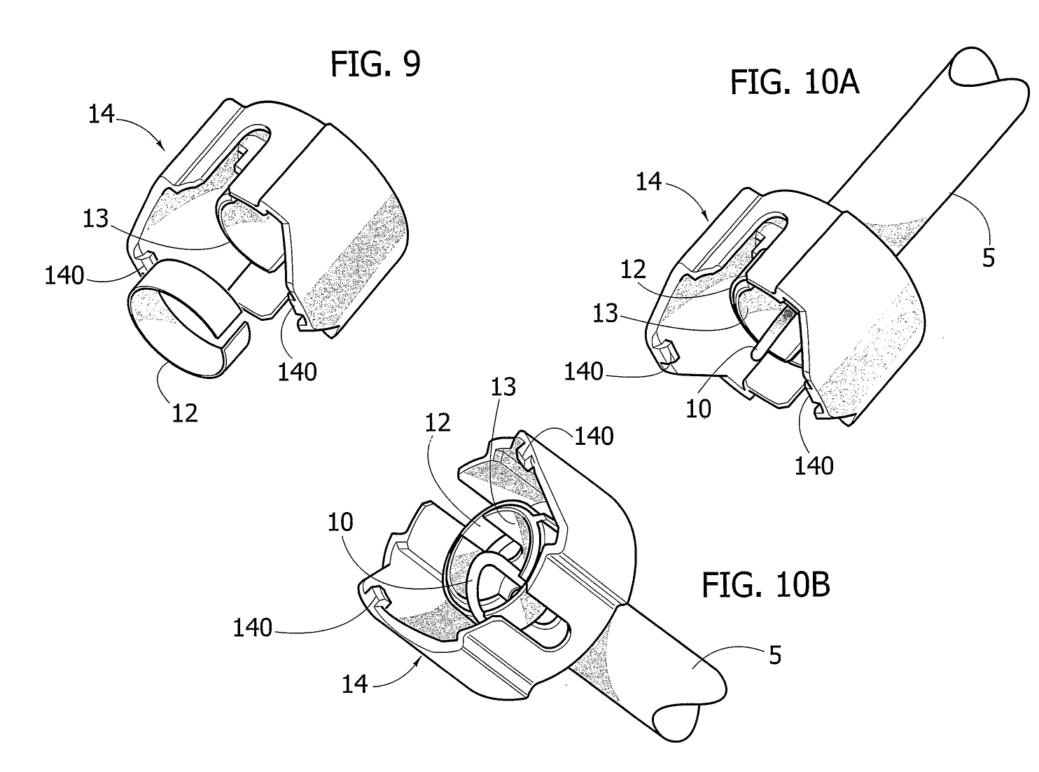

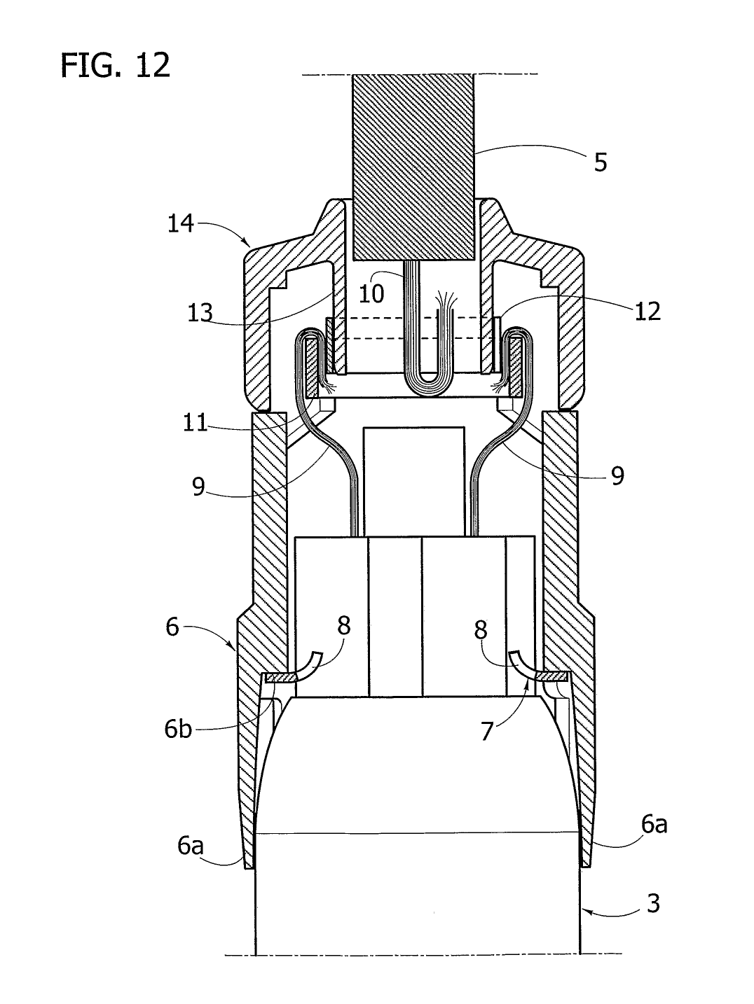

With reference first of all to FIGS. 4, 5 and 12, the embodiment of the device of the invention illustrated herein comprises a first body 6, in the form of a substantially tubular casing, made of electrically insulating plastic material. The casing 6 has an end mouth 6a (FIG. 12), designed to be fitted on the end portion 3 of the fluorescent tube that terminates with a closed end 3a, obtained by means of a fusion welding and having an oval conformation in cross-sectional view (see FIG. 5).

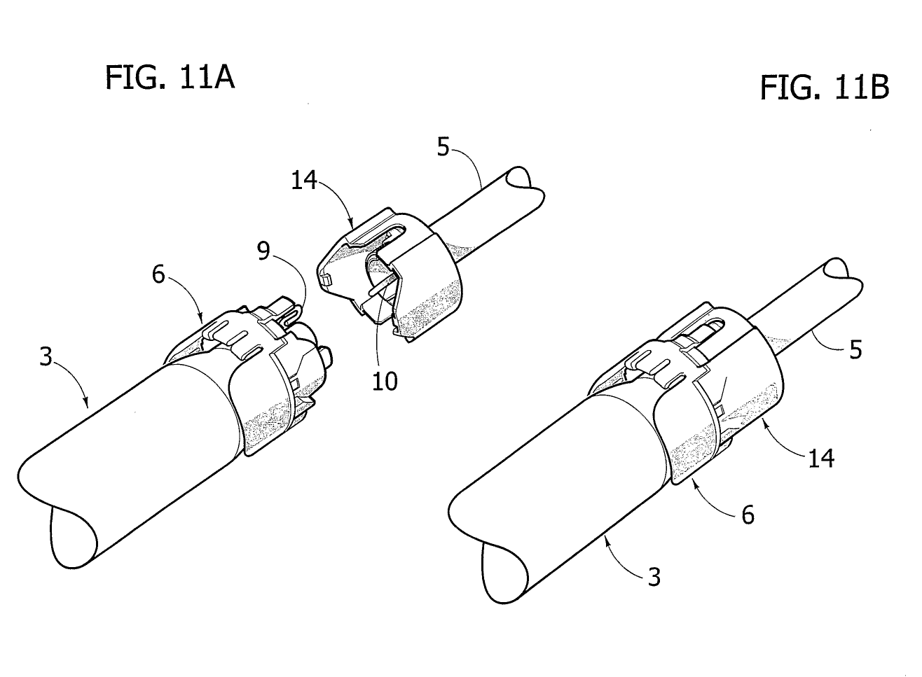

In order to be stably positioned on the portion 3a of the fluorescent tube, mounted inside the tubular casing 6, against an annular contrast surface 6b (FIG. 12), is the peripheral portion of a metal lamina 7 shaped like a diaphragm, which is clearly visible in FIGS. 6A, 6B. The lamina 7 has two bent tabs 7a, diametrally opposite to one another, orthogonal with respect to the plane of the lamina, which are received within corresponding seats defined in the inner surface of the tubular casing 6. Defined in the wall of the metal lamina 7 is an indented central opening that gives rise to a plurality of elastically flexible teeth 8 that undergo deformation out of the plane of the lamina 7 (FIG. 12) following upon its assembly on the end 3a of the fluorescent tube so as to ensure with their elastic return the friction sufficient to keep the casing 6 in a stable position on the glass body of the fluorescent tube.

With reference once again to FIG. 12, in the example illustrated the electrode associated to the end of the fluorescent tube is connected to two electrical conductors 9, which are to be connected electrically to an electrical conductor 10 of the supply cable 5. For this purpose, the end of the tubular casing 6 opposite to the mouth 6a receives and supports (see also FIGS. 8A and 8B) a cylindrical ring 11 made of electrically conductive material, for example steel, designed to receive inside it a further cylindrical ring 12, which is also made of electrically conductive material and is fitted on an internal tubular portion 13 of a second body 14 made of plastic material associated to the supply cable 5.

As is clearly visible in FIG. 12, the metal rings 12, 11 are inserted one inside the other with interposition of bent terminal portions both of the conductors 9 and of the conductor 10 so as to remain clamped by friction between them. The first body constituted by the tubular casing 6 and the second body moreover envisage parts of mutual engagement (respectively, recesses 60 and flexible teeth 140), which contribute to the coupling between the bodies 6, 14.

FIGS. 6A and 6B illustrate a first step in which the metal lamina 7 is mounted on the casing 6.

FIG. 7 shows a second step, in which the casing 6, with the lamina 7 associated thereto, is fitted on the end 3a of the fluorescent tube.

FIGS. 8A and 8B show assembly of the ring 11 on the body 6.

FIG. 9 illustrates a further step in which the ring 12, which, as may be seen in FIG. 9, is split, is widened elastically to be fitted on the tubular portion 13 of the body 14. In the undeformed condition, the ring 12 has a slightly smaller diameter than the tubular portion 13 so that, once the ring 12 has been widened and fitted on the tubular portion 13, it remains stably associated to the portion 13.

FIGS. 10A, 10B illustrate the further step in which the body 14 is associated to the supply cable 5 and the conductor 10 is bent at its end, causing it to pass from inside to outside the ring 12.

FIGS. 11A and 11B illustrate the final step of coupling of the two bodies 6, 14, with consequent insertion of the ring 12 inside the ring 11 and clamping between said rings of the conductors 9, 10 so as to make the electrical connection.

As emerges clearly from the foregoing description, the device according to the invention, on the one hand, guarantees stability of its positioning on the end of the fluorescent tube and, on the other hand, enables rapid execution of the operation of connection. At the same time, the device has a relatively simple and low-cost structure, as well as being easy to use.

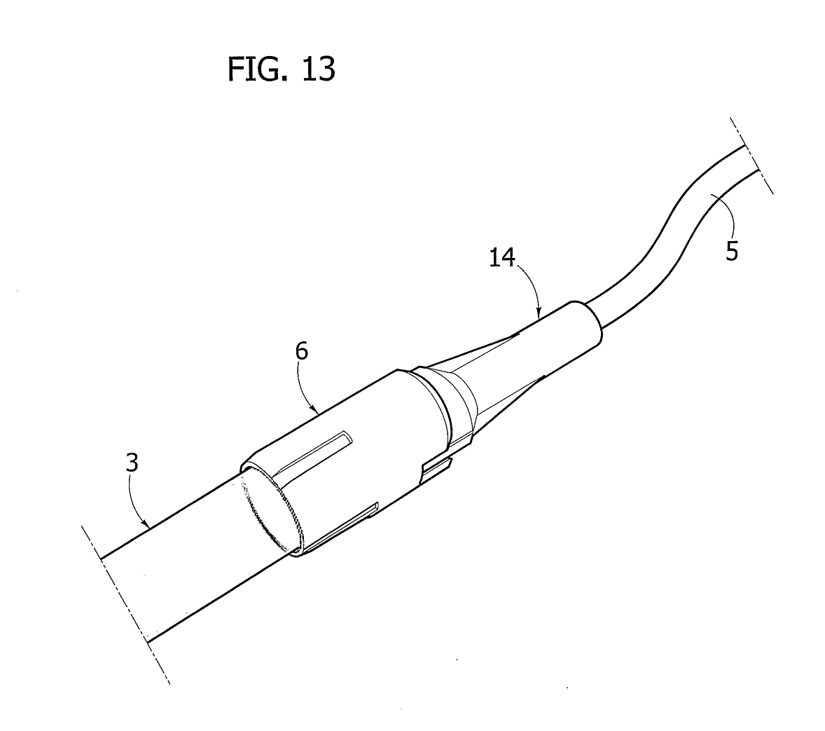

FIGS. 13-19 show a second embodiment of the connector device of the invention. In these figures parts corresponding in structure and/or function to those of the first embodiment are designated by the same reference numerals.

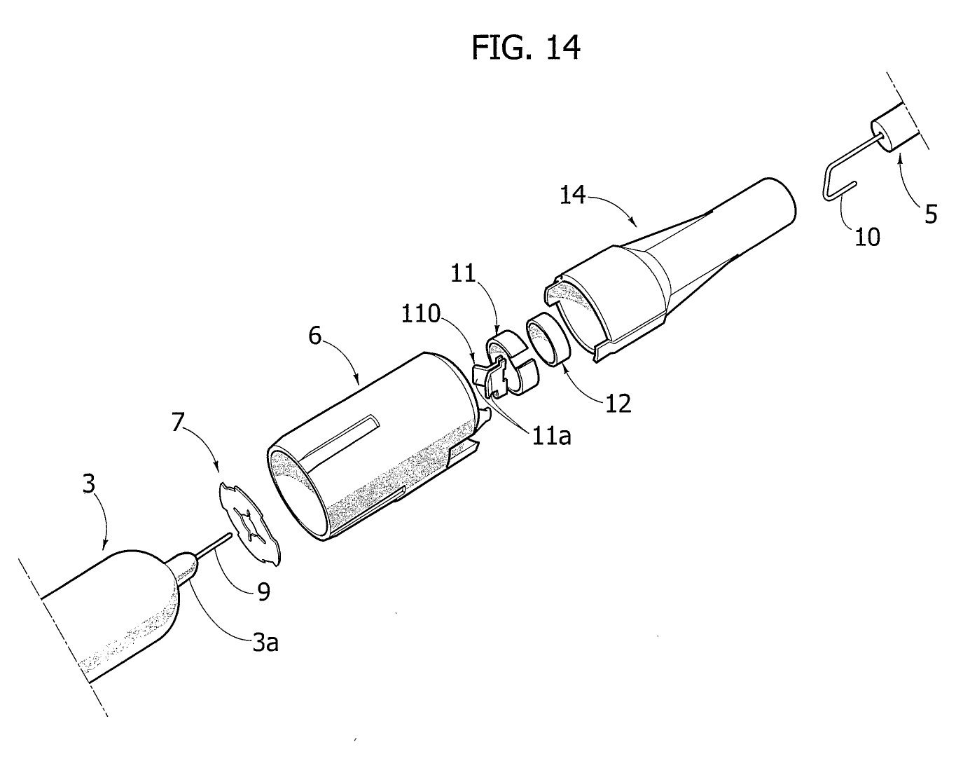

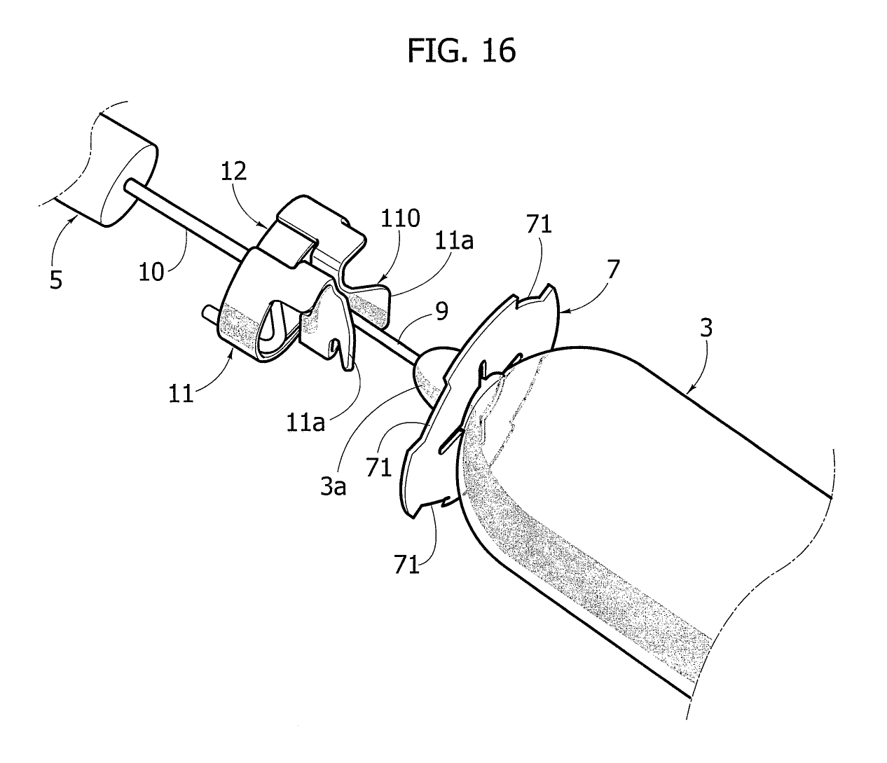

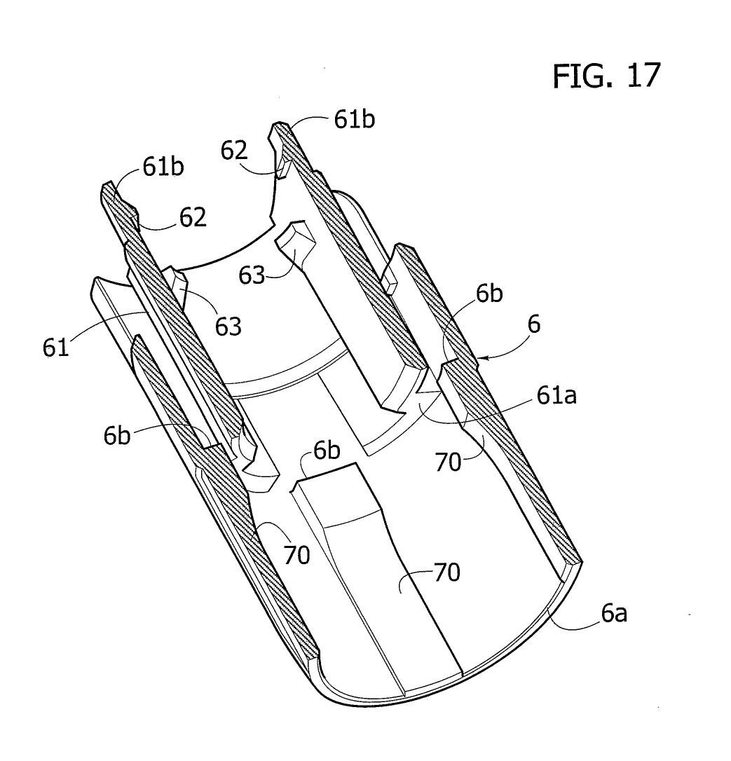

A first major difference of the second embodiment with respect to the first embodiment lies in that in this case only the bent portion of the wire 10 of the supply cable 5 (see FIG. 14) is interposed between the two cylindrical metal rings 11, 12. A single wire 9 extends out of the end 3a of the fluorescent tube 3. Contrary to the first embodiment, wire 9 has not a bent end portion pinched between the two cylindrical rings 11, 12. Wire 9 extends straight axially out of tube 3 and is engaged within a clump 110 defined by two projections 11a which are formed in one piece with the outer cylindrical ring 11, as clearly shown in FIG. 16.

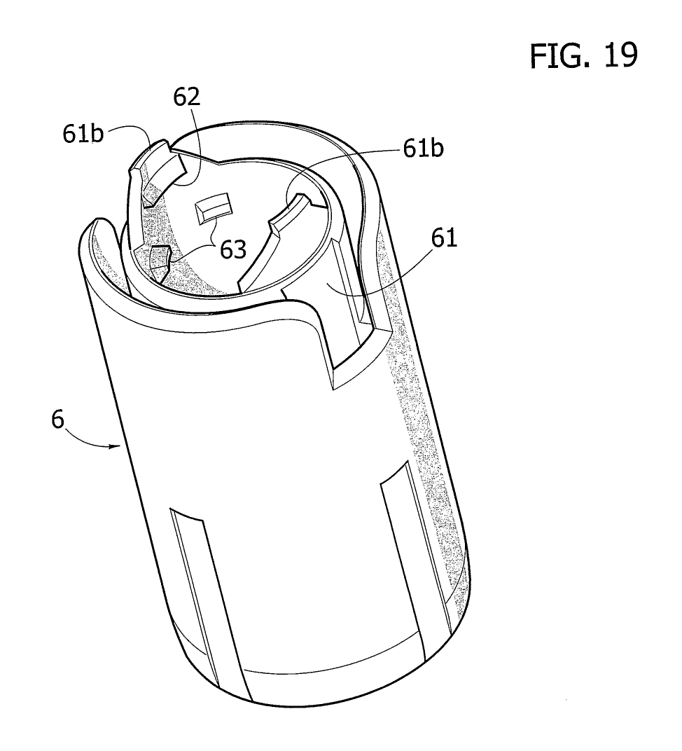

Another difference of the second embodiment lies in that the above mentioned outer cylindrical ring 11 is carried by the tubular housing 6 constituting the first body of the connector device through an inner sleeve 61 (see in particular FIGS. 17 and 19) which is formed in one-piece with the wall of the tubular housing 6. The cylindrical wall of sleeve 61 is spaced inwardly away from the wall of the tubular housing 6, but the two portions are connected together by bridging portions which are clearly visible in FIG. 17. At its end facing away from the mouth 6a, the inner sleeve 61 has two diametrically opposite axial projections 61b (FIG. 19) on whose inner surfaces two shoulders 62 (FIG. 17) are formed facing towards a number of projections 63 formed on the inner surface of sleeve 61. The cylindrical ring 11 is firmly clumped within the inner sleeve 61 between the shoulders 62 and projections 63.

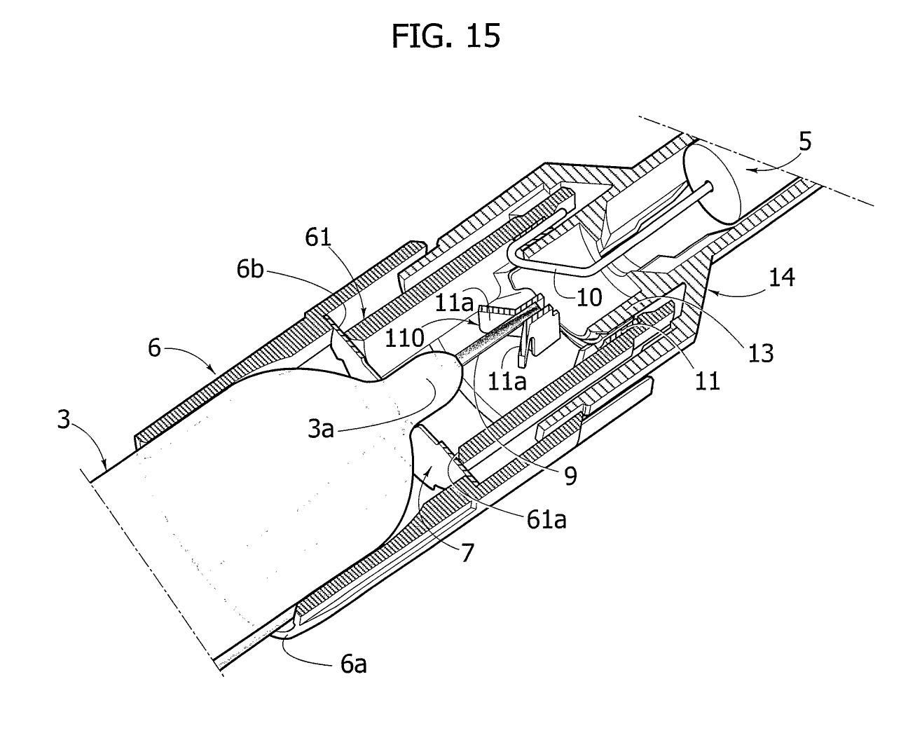

Another difference of the second embodiment relates to the way in which the metal sheet 7 is mounted within the tubular housing 6. In the second embodiment, the inner wall of the tubular housing 6 is formed with a plurality of axial ridges 70 (see FIG. 17) extending from the end mouth 6a almost half-way of the total axial length of the tubular housing 6. The ends of the axial ridges 70 define in this case shoulder surfaces 6b for supporting the metal sheet 7. As immediately apparent from FIGS. 15 and 17, contrary to the first embodiment, in this second embodiment the above mentioned shoulder 6b faces away from the end mouth 6a. Moreover, the inner sleeve 61 has an end surface 61a facing towards the end mouth 6a of the tubular housing which is axially adjacent to the above mentioned shoulder surfaces 6b, so that the metal sheet 7 is mounted axially interposed between shoulders 6b and the above mentioned end surface 61a of the inner sleeve 61 (see FIG. 15). For enabling the metal sheet 7 to be mounted, metal sheet 7 is formed with a plurality of notches 71 (FIG. 16) which cooperate with ridges 70 when the metal sheet 7 is mounted within the tubular housing 6 starting from the end mouth 6a. Once the metal sheet 7 has reached its axial position between shoulder portions 6b and the end surface 61a of sleeve 61, it is rotated, so as to bring the outer portions of the metal sheet 7 interposed between notches 71 in contact with the shoulder portions 6b.

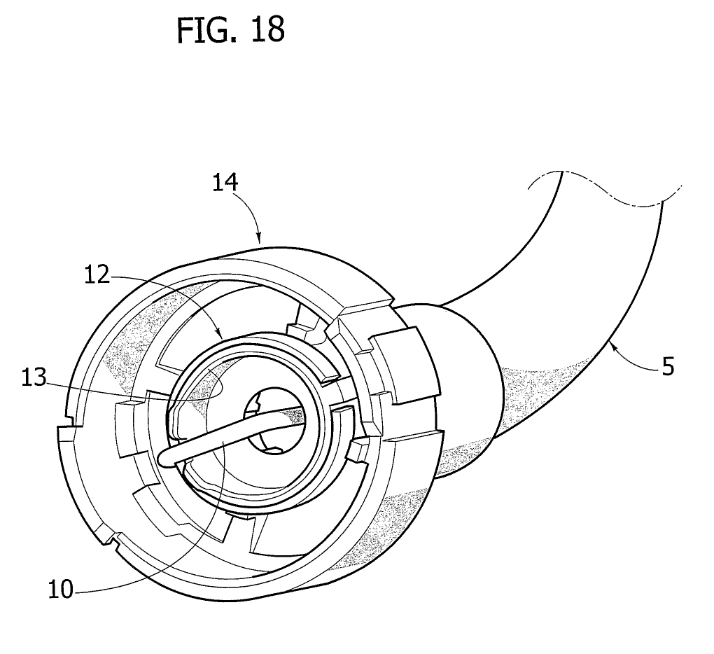

As it will be immediately apparent from the foregoing description, the cylindrical metal ring 11 and the metal sheet 7 are mounted within the tubular housing 6 in the way described above, whereupon the cylindrical housing 6 is mounted over the fluorescent tube 3 as shown in FIG. 5 until the wire 9 extending out of the tube 3 is received and held within clamp 110. At that point, the second body 14 with the associated cylindrical ring 12 and the wire bent portion 10 (FIG. 18) can be coupled with the housing 6 in the position shown in FIG. 13, so that the cylindrical ring 12 is received within the cylindrical ring 11 with the bent wire portion 10 pinched therebetween, thus establishing an electric connection between wire 9, clamp 110, ring 11, ring 12 and wire

From the foregoing description it is clearly apparent that the second embodiment of the invention adds further advantages in terms of easy and quick connecting operations and safe and stable connection.

Naturally, without prejudice to the principle of the invention, the details of construction and the embodiments may vary widely with respect to what is described and illustrated herein purely by way of example, without thereby departing from the scope of the present invention.

1-10. (canceled)

11. Connector device for connecting a cold cathode of a neon or fluorescent tube lamp to a supply cable, comprising:
a first body, made of an electrically insulating material, provided with means for mounting thereof on one end of the fluorescent tube,
a second body, made of electrically insulating material, adapted to be associated to one end of the supply cable, and
first and second coupling elements carried by said first body and said second body respectively and made of electrically conductive materials,
said first body and said second body being adapted to be coupled with each other in a condition in which said first and second coupling elements come into engagement with each other and also with a first wire connected to the electrode of the fluorescent tube and a second wire forming part of said supply cable,
so that in said engagement condition the electrode of the fluorescent tube is electrically connected to said supply cable through said first wire, said first and second coupling elements and said second wire,
wherein said first and second coupling elements are in form of two concentric cylindrical rings, substantially coaxial with the fluorescent tube.

12. Connector device according to claim 11, wherein said first body is in form of a substantially tubular housing and said means for mounting said first body on the end of the fluorescent tube comprise a diaphragm-like metal sheet having a peripheral portion secured to the inside of said tubular housing and a plurality of elastically deformable teeth, adapted to engage said end of the fluorescent tube, so as to hold said tubular housing thereon.

13. Connector device according to claim 12, wherein said tubular housing has one end mouth adapted to be mounted over the end of the fluorescent tube and having an inner shoulder for supporting the peripheral portion of said metal sheet, and in that said tubular housing has its end opposite to said end mouth adapted to receive and support the respective cylindrical ring.

14. Connector device according to claim 13, wherein said second body has a substantially cup-shaped configuration, with an inner tubular portion adapted to receive thereon said cylindrical ring associated to said second body.

15. Connector device according to claim 14, wherein said cylindrical ring associated to the second body is a split ring mounted on said inner tubular portion of said second body.

16. Connector device according to claim 11, wherein at least one of said first and second wires has a bent terminal portion which is interposed between said rings when these are mutually engaged one within the other, so that these rings become locked with each other by friction.

17. Connector device according to claim 16, wherein both said first and second wires have bent terminal portions which are interposed between said rings when these are mutually engaged one within the other, so that these rings become locked with each other by friction.

18. Connector device according to claim 16, wherein said second wire forming part of said supply cable has a bent terminal portion which is interposed between said rings when these are mutually engaged one within the other, so that these rings become locked with each other by friction, whereas said first wire connected to the electrode of the fluorescent tube is engaged within a clamp defined by projections formed in one-piece with said ring defining the first coupling element.

19. Connector device according to claim 13, wherein said inner shoulder formed in said tubular housing for supporting said metal sheet faces away from said end mouth of the tubular housing, and
that said respective cylindrical ring is carried by said tubular housing through an inner sleeve formed in one-piece within said tubular housing and having one end surface facing towards said end mouth of the tubular housing which is axially adjacent to said inner shoulder,
so that said metal sheet is axially interposed between said inner shoulder of the tubular housing and said end surface of the inner sleeve.

20. Connector device according to claim 19, wherein said inner shoulder is defined by the ends of a plurality of axial ridges formed on the inner surface of said tubular housing, and in that said metal sheet has outer notches for cooperation with said inner axial ridges so that said metal sheet can be mounted within the tubular housing by inserting it from said end mouth and then rotating it in position between said shoulder of the tubular housing and said end surface of the inner sleeve.
